(19) United States
(12) Patent Application Publication
(10) Pub. No.: US 2015/0177976 A1
(43) Pub. Date: Jun. 25, 2015

(54) METHOD AND SYSTEM FOR SCROLLING A DATA SET ACROSS A SCREEN

(71) Applicants: Razvan Ionescu, Bucharest (RO); Radu-Marian Ivan, Bucharest (RO); Ionut-Valentin Vicovan, Bucharest (RO)

(72) Inventors: Razvan Ionescu, Bucharest (RO); Radu-Marian Ivan, Bucharest (RO); Ionut-Valentin Vicovan, Bucharest (RO)

(73) Assignee: Freescale Semiconductor, Inc., Austin, TX (US)

(21) Appl. No.: 14/416,720

(22) PCT Filed: Aug. 8, 2012
(86) PCT No.: PCT/IB2012/054048

§ 371 Date: Jan. 23, 2015

(51) Int. Cl. G06F 3/0485

(52) U.S. Cl. CPC G06F 3/04855

(57) ABSTRACT

A method of scrolling a data set stored in a memory across a screen is described. The method comprises presenting a user interface widget on the screen. The user interface widget comprises one or more linear scroll bars and a rotation-sensitive scroll area. The method further comprises receiving one or more user inputs to the user interface widget, determining at least a scroll speed, a scroll direction and a scroll resolution from the one or more user inputs to obtain a scroll control signal, and scrolling the data set across the screen in accordance with the scroll control signal. A computer program product comprising instructions for causing a processor system to perform a method of scrolling a data set stored in a memory across a screen is described. A user interface widget is described. A device comprising a processor arranged to perform such method is described.

### FIELD OF THE INVENTION

This invention relates to a method and system for scrolling a data set across a screen.

### BACKGROUND OF THE INVENTION

If a user wants to view a large data set on a screen, the screen's capabilities to display the data set are limited by the size and resolution of the screen. Therefore, the data set if usually scrolled across the screen, whereby only a part of the data set is made visible. Scrolling is conventionally facilitated by providing a scroll bar at a side of the screen. Such conventional scroll bar comprises a linear bar representing the length of the data set and a slider which can be moved by the user along the linear bar, whereby the position of the slider along the linear bar corresponds to the relative position of the visible part on the complete data set. The user may e.g. use a mouse to drag the slider along the linear bar, or the screen may be a touch screen and the user may use his finger or a stylus to drag the slider along the bar. It may be difficult with such conventional scroll bars to scroll through large data sets or using a small screen, where the scrolling may be imprecise.

### SUMMARY OF THE INVENTION

The present invention provides a method for scrolling a data set across a screen, an associated computer program product and an associated system as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 and FIG. 2 schematically shows an example of an embodiment of a user interface widget;

FIG. 3 schematically shows an example of another embodiment of a user interface widget;

FIG. 4, FIG. 5, FIG. 6a and FIG. 6b schematically illustrate an example of a method of scrolling using the user interface widget;

FIG. 7a and FIG. 7b schematically shows devices for scrolling a data set across a screen;

FIG. 8 schematically shows another example of a user interface widget;

FIG. 9a and FIG. 9b schematically shows again another example of a user interface widget;

FIG. 10 schematically illustrates an example of a user input processing system;

FIG. 11 schematically illustrates an example of an embodiment of a method;

FIG. 12 schematically shows an exemplary user interaction system; and

FIG. 13 shows a computer readable medium comprising a computer program product

### DETAILED DESCRIPTION OF THE PREFERRED EMBODIMENTS

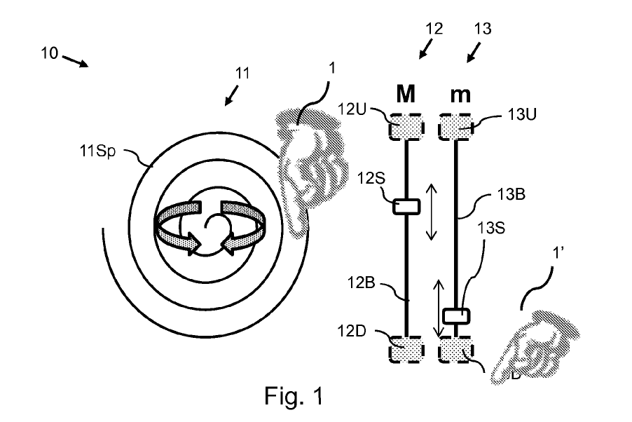

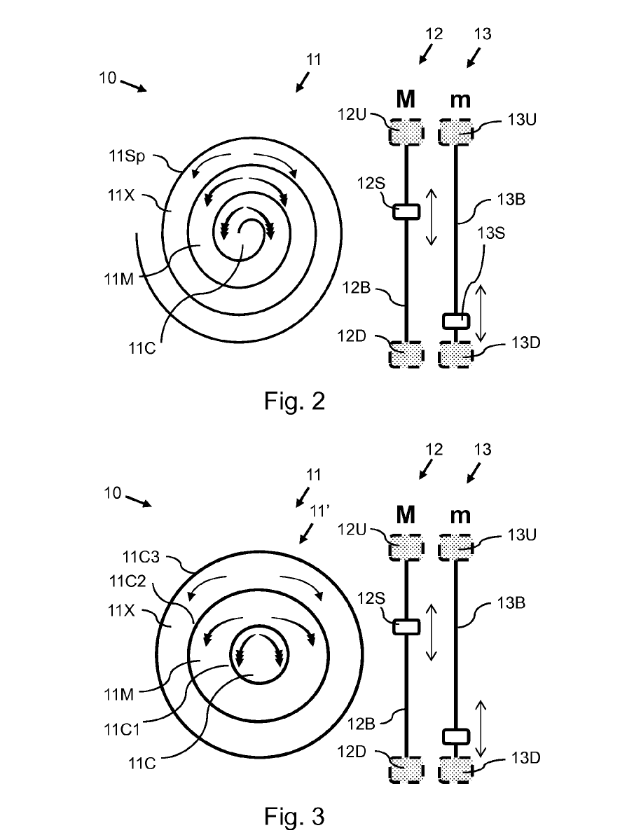

FIG. 1 and FIG. 2 schematically shows an example of an embodiment of a user interface widget 10 as presented on a screen, suitable for scrolling a data set across the screen. The data set has a data set size and a data set resolution. In the non-limiting examples below, the data set is represented by a table, the data set size corresponds to the total number of rows of the table and the data set resolution is one row. FIG. 1 shows a user interaction with the user interface widget, by a user giving user inputs to the user interface widget 10 by touching the screen with his finger 1, 1′. Alterative user input methods may also be used, such as using a mouse. The user interface widget 10 comprises a rotation-sensitive scroll area 11 and one or more linear scroll bars 12, 13, in this example two.

In the example shown in FIG. 1 and FIG. 2, the rotation-sensitive scroll area 11 comprises a presentation of a spiral object 11Sp, the spiral object having a plurality of turns. The user may scroll up and down by given a rotational user input, as indicted with finger 1 in FIG. 1, to the rotation-sensitive scroll area 11: a counter-clockwise input may e.g. correspond to scrolling up, whereas a clockwise input may correspond to scrolling in the opposite direction, i.e., scrolling down. The sense of rotation of the user input may thus be detected and used to determine the scroll direction. By moving along the spiral object 11Sp, the user may thus scroll up or down. Scrolling using the spiral object 11Sp may correspond to scrolling at the data set resolution, e.g., at one row. Hereby, an accurate scrolling may be obtained. The rotation-sensitive scroll area 11 comprises a plurality of regions, of which a central region 110, a middle region 11M and an outer region 11X are shown. The central region 110, the middle region 11M and the outer region 11X are associated with scrolling at different scroll speeds, as is indicated with the differently-headed arrows in FIG. 2. Each region may comprise one or more turns of the spiral object. The scroll speed associated with the central region 110 may e.g. be larger than the scroll speed associated with the middle region 11M, which may be larger than the scroll speed associated with the outer region 11X. A user may thus give a rotational input at the central region 110 to scroll the data set across the screen at a high speed, or a rotational input at the outer region 11X to scroll the data set across the screen at a low speed. Hereby, the scrolling may be accelerated and decelerated, which may provide a convenient scrolling. The central region 110, middle region 11M and outer region 11X may each be associated with scrolling at a scroll resolution corresponding to the data set resolution. Hereby, full-resolution scrolling may be provided irrespective of speed.

The two linear scroll bars comprise a major scroll bar 12 and a minor scroll bar 13. The major scroll bar and the minor scroll bar are associated with different scroll resolutions. The major scroll bar 12 has a major slider 12S movable along a major bar 12B. The minor scroll bar 13 has a minor slider 13S movable along a minor bar 13B, as indicated with finger 1′ in FIG. 1. The user may scroll up and down with a major scroll resolution, e.g., corresponding to blocks of e.g. 100 rows of the table, by moving the major slider 12S along the major bar 12B. Hereby, the user may scroll to an approximate location within the data set in a quick and/or convenient manner. The major scroll resolution may, e.g., be a pre-determined size or a pre-determined fraction of the data set size. For an accurate scrolling, the user may scroll up and down with a minor scroll resolution, e.g. corresponding to the data set resolution, such as one row, by moving the minor slider 13S along the minor bar 13B. Hereby, the user may scroll to a precise location within the data set. The major scroll bar 12 may further comprise up and down scroll tap regions 12U, 12D at the ends of the major bar 12B. By providing a user input as a tap to the up scroll tap region 12U of the major scroll bar 12, a scrolling of one step in the major scroll resolution in the upward direction may be obtained. By providing a user input as a tap to the down scroll tap region 12D of the major scroll bar 12, a scrolling of one step in the major scroll resolution in the downward direction may be obtained. The minor scroll bar 13 may further comprise up and down scroll tap regions 13U, 13D at the ends of the minor bar 13B. Tapping the up or down scroll tap region of the minor scroll bar 13 results in an up of downward scroll with the minor scroll resolution. Hereby, a convenient way of scrolling at one resolution step may be provided.

FIG. 3 schematically shows an example of another embodiment of a user interface widget 10. The user interface widget 10 of FIG. 3 differs from that described with reference to FIG. 1 and FIG. 2 in that the spiral object 11Sp of the rotation-sensitive scroll area 11 is replaced by a circular object 11′. The circular object 11′ comprises a plurality of concentric circles 1101, 1102, 1103 forming central region 11C, middle region 11M and outer region 11X. A user may give a rotational input at one of the concentric circles, with the scroll speed being dependent on the radius of the concentric circle used by the user. For example, the scroll speed may decrease with increasing radius. Hereby, an accurate scrolling, at full scroll resolution and at low scroll speed, may be obtained at the most outer circle, whereas a very fast scroll speed may be obtained at the center of the circular object 11′.

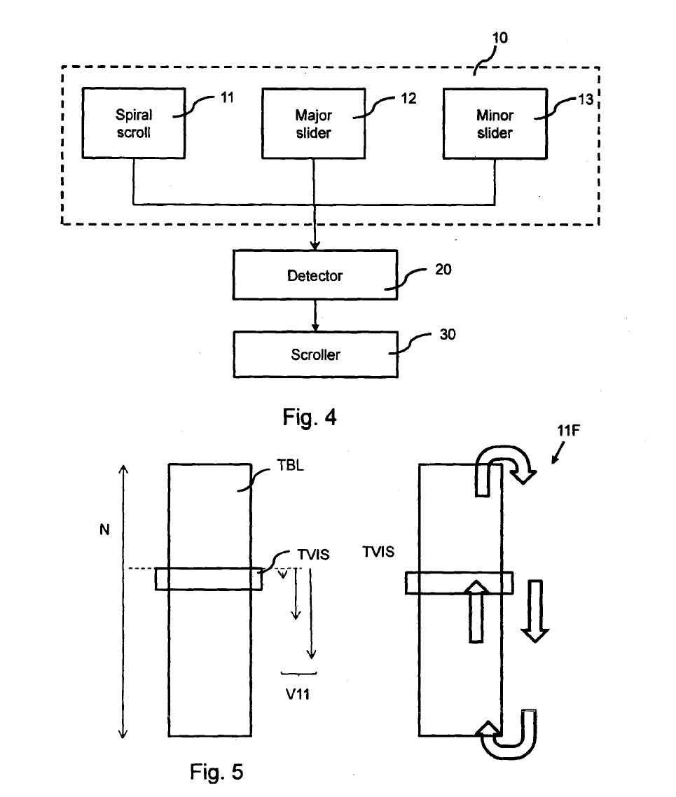

FIG. 4, FIG. 5, FIG. 6a and FIG. 6b schematically illustrate an example of a method of scrolling using a user interface widget as described above.

FIG. 4 schematically shows a scroll system comprising user interface widget 10, a detector 20 and a scroller 30. The user interface widget 10 comprises a rotation-sensitive scroll area 11, a major scroll bar 12 and a minor scroll bar 13. The user interface widget 10 is presented on a screen to which a user can give user inputs. The detector 20 is arranged to detect user inputs to the user interface widget 10 to detect user inputs to the rotation-sensitive scroll area 11, the major scroll bar 12 and the minor scroll bar 13. The detector 20 is arranged to determine a scroll speed, a scroll direction and a scroll resolution from the user inputs, to generate a scroll control signal indicating the scroll speed, scroll direction and scroll resolution as determined, and to provide the scroll control signal to the scroller 30. The scroller 30 is arranged to scroll the data set across the screen in accordance with the scroll control signal. Without being limited to the data set being a table, a data set in the form of a table will be used in FIG. 5, FIG. 6a and FIG. 6b to describe the scrolling according to an example. It will be appreciated that the data set may alternatively be, for example, a text, a computer program text, measurement data, a webpage, a graphical visualisation, or any other item that may be visualized on a screen and allows to be scrolled across the screen.

FIG. 5 schematically shows a table TBL representing an exemplary data set. The table TBL has a data set size defined by its number of rows N. The table has a data set resolution defined as the size of one row. The screen on which the user wants to view the table has a screen size allowing to show only a small part TVIS of the total table, corresponding to a visible number of rows W. When using the rotation-sensitive scroll area 11, the table may be scrolled across the screen at the data set resolution, i.e. at the resolution of one row, but at different scroll speeds as indicated by the three arrows V11 in dependence on the radial position of the user input on the rotation-sensitive scroll area 11.

For scrolling at a lower resolution, i.e., at a larger grain size, the table TBL may be considered to be composed of a plurality of S subsets TBLS1, TBLS2 and TBLS3 as shown in FIG. 6a. In the example shown, the plurality is three. The size MAJ of the subsets may be equal for all subsets, or for all subsets except for the last subset of the plurality. For example, the size of each of the first (S−1) subsets may be NS=ceil(N/S) rows and the size of the last subset may be NLAST=N −(S−1)×ceil(N/S). The size of a subset may be larger than the visible number of rows W of the visible part TVIS. The major scroll bar 12 may be used to scroll at a granularity corresponding to the subset size NS, which may further be referred to as the subset resolution. Thus, if the table TBL is scrolled upward by one step in the subset resolution, the scroll effectively corresponds to a jump of MAJ rows, as is indicated in FIG. 6a. If the table TBL is scrolled by more steps in the subset resolution, by moving the major slider 12S along the major slider bar 12B over some distance, the scroll effectively corresponds to multiple jumps of MAJ rows. Hereby, scrolling may be effected across the screen at a low resolution, i.e. in steps of MAJ rows at a time, hereby selecting one of each subsets as a selected subset TBLS.

Optionally, when scrolling of the table across the screen in the scroll direction reaches an end of the table (i.e., the first row, or the last row) of the table and scrolling cannot continue further in the scroll direction, the scrolling continues again from the opposite end, as is indicated with arrows 11F. This may be referred to as folding around. Thus, the scrolling behaves as if the table is extended with copies of itself at either end. Hereby, a fast scroll towards the opposite end may be provided.

The minor scroll bar 13 may be used to scroll the selected subset TBLS across the screen at the data set resolution, i.e., at a resolution of one row, to hereby effectively select which W rows of the selected subset TBLS is the visible part TVIS of the table, as indicated in FIG. 6b for a scroll across the screen over a one-row distance. If the selected subset TBLS is scrolled by more steps, by moving the minor slider 13S along the minor slider bar 13B over some distance, the scroll effectively corresponds to a scroll over a distance of a small number rows within the selected subset TBLS. With the major scroll bar 12 and the minor scroll bar 13, an accuracy of scrolling to a wanted position may be significantly improved compared to a prior art, single scroll bar. For example, if a table has 10000 rows and a prior art scroll bar has a length of 10 cm, a scroll over a 10 row distance would be reflected by moving the slider of the single scroll bar along the single scroll bar over a distance of 10×10/10000 cm=0.01 cm, which may be impossible to achieve. Using a major and a minor scroll bar, with a subset resolution corresponding to 100 rows, the minor scroll bar is used to scroll within a subset of 100 rows, and a scroll over a 10 row distance may be effected by moving the minor slider 13S along the minor scroll bar 13B over a distance of 10×10/100=1 cm and at a precision of 0.1 cm, which may in practice be well achievable for a wide range of types of screen and types of user input, e.g. on a touch screen using a finger, on a touch screen using a stylus, or a screen using a mouse. Likewise may a scroll over 410 rows distance be relatively easily be obtained by moving the major slider over a distance of 0.4 cm at a precision of 0.1 cm to move 400 rows and the minor slider over 1 cm at a precision of 0.1 cm to move 10 rows , whereas a precision of 0.001 cm would be needed when a prior art single slider would be used.

The major scroll bar 12 may thus be associated with scrolling the data set across the screen at a subset resolution in response to a user input to the major scroll bar 12 to obtain a selected subset TBLS of a plurality of subsets TBLS1, TBLS2, TBLS3 of the data set TBL, the plurality of subsets together forming the data set, and the minor scroll bar 13 being associated with scrolling the selected subset across the screen at the data set resolution in response to a user input to the minor scroll bar 13.

A user interface widget 10 having the rotation-sensitive scroll area 11, the major scroll bar 12 and the minor scroll bar 13 may thus be used to accurately scroll the data set across the screen, by, where appropriate, suitable controlling scroll direction, scroll speed and/or scroll resolution. The rotation-sensitive scroll area 11 may allow for a continuous and smooth scrolling at different speeds. The major scroll bar 12 may allow for fast scrolling at reduced resolution to quickly scroll to a certain range within the data set. The minor scroll bar 13 may allow for scrolling the selected subset at the full data set resolution. The minor scroll bar 13 may be restricted to scrolling the selected subset only and prevent an unintended scrolling of the neighbouring subset. The rotation-sensitive scroll area 11 may allow for scrolling from the selected subset to the neighbouring subset if a user wants to scroll across subset boundaries. The rotation-sensitive scroll area 11, the major scroll bar 12 and the minor scroll bar 13 may thus be used to smoothly scroll over subset boundaries.

As an example, the major scroll bar 12 may be scrolled at a subset resolution corresponding to 100 rows. The major scroll bar 12 may thus correspond to effectively jumping between subsets consisting of rows 1-100, 101-200, 201-300, . . . , 99901-10000. A user may thus use the major scroll bar 12 to e.g. quickly scroll to, for example select the subset consisting of rows 20101-20200. The user may, when this subset is selected, use the minor scroll bar 13 to scroll with the full dataset resolution (of one row) inside the subset, for example from 20101 to 20102, 20103, 20104 and further. Alternatively, the user may use the rotation-sensitive scroll area 11 to scroll likewise, by providing a rotational input to the rotation-sensitive scroll area 11 corresponding to a low scroll speed, such as the outer region 11X, to scroll from 20101 to 20102, 20103, 20104 and further at the low scroll speed, To scroll in the opposite direction, the minor scroll bar 13 may prevent scrolling outside the subset, such as beyond row 20101 to row 20100. If the user wishes to scroll beyond row 20101 in such opposite direction, the user may however use the rotation-sensitive scroll area 11 to scroll to row 20100, 20099, 20098, 20097, . . . . The user may, in this example, also use the rotation-sensitive scroll area 11 to scroll in any direction at a higher scroll speed, for example if the user wishes to scroll several 10s of rows, e.g. 40 rows, or if the user wishes to scroll a distance of about a few subsets, such as e.g. about 250 rows.

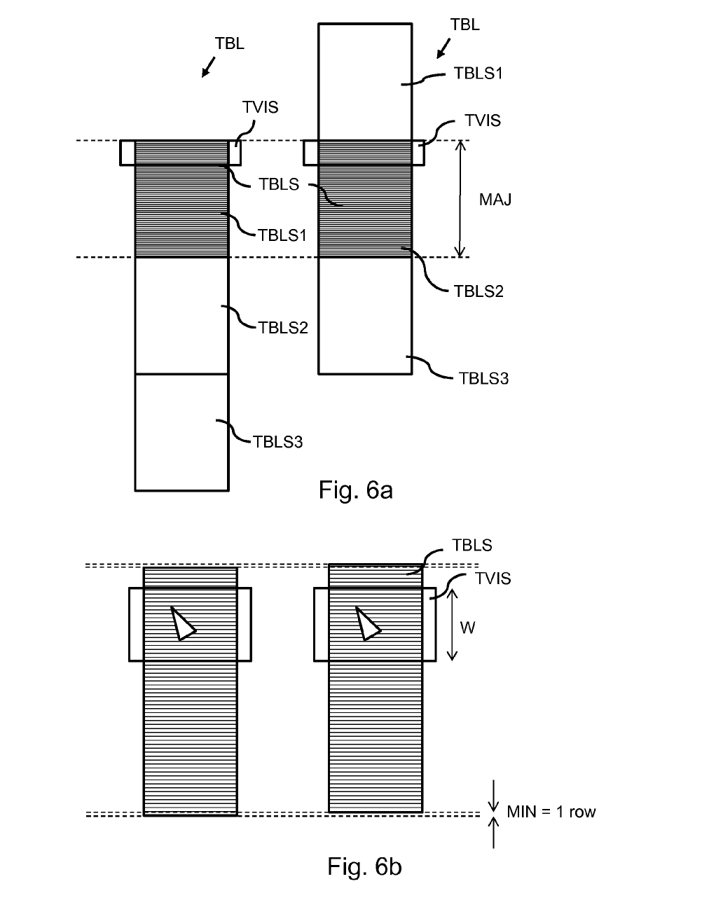

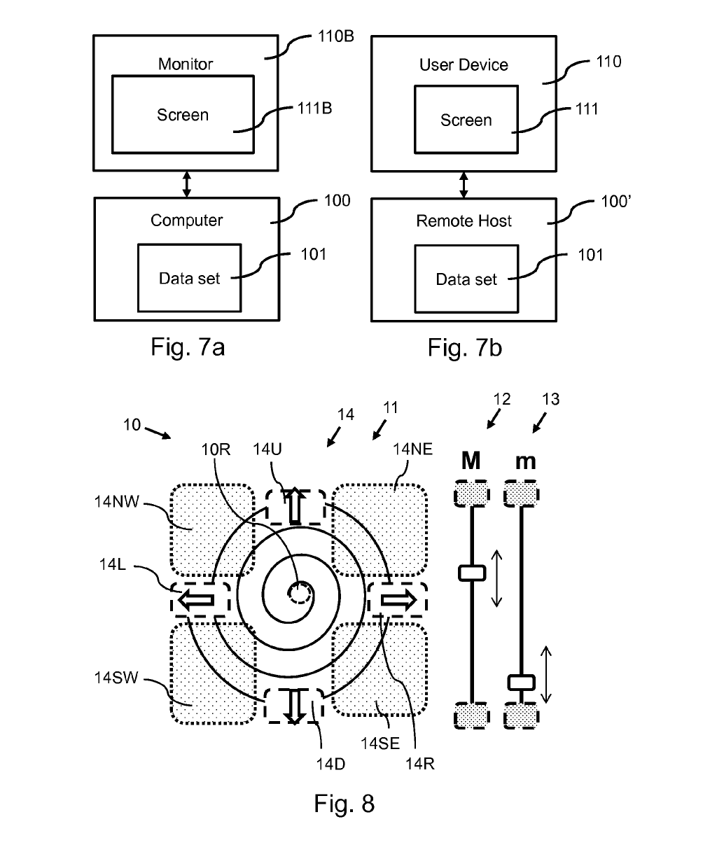

FIG. 7a and FIG. 7b schematically show devices for scrolling a data set across a screen.

FIG. 7a schematically shows a computer 100 having a data set 101 stored in a memory and connected to a computer monitor 110B having a touch screen 111B during a scrolling operation. The touch screen 11B may have a screen diagonal in a range of 40-100 cm. The user interface widget 10 is presented by the computer 100 on the screen and touch inputs to the screen are provided as user inputs to the user interface widget and received by the computer 100. The computer 100 determines a scroll speed, scroll direction and scroll resolution from the user inputs and scrolls the data set 101 across the screen 111B accordingly. The screen 111B may be operated as a touch screen. The user interface widget 10 may improve the scroll control compared to a known single slider.

FIG. 7b schematically shows a similar computer 100′ having a data set 101 stored in a memory. However, the data set 101 on the computer 100′ is now accessed from a small-sized touch screen 111 of a user device 110, such as a smartphone or a tablet. The touch screen 111 may have a screen diagonal in a range of 8-20 cm. The computer 100′ thus acts as a remote host to the user device 110. The user interface widget 10 may be presented as a transparent overlay across part of the data set as shown on the screen. Hereby, a user interface widget 10 of a reasonable size is provided on a relatively small screen 111, whereby a largely improved scroll control may be provided compared to a known single slider.

FIG. 7b provides an exemplary embodiment of a system comprising a host device 100′ and a user device 110, the system having a memory for storing a data set, the user device having a screen 111, the host device 100 and the user device 110 being arranged to perform a method of scrolling a data set TBL stored in the memory of the host device 100′ across the screen 111 of the user device 110.

The systems shown in FIG. 7a and FIG. 7b may be operable with or without further user input devices, such as a keyboard or a mouse. These further user input devices may support scrolling and/or other user actions, such as cursor movement, clicking or data operations. The computer monitor 110B may typically be used in combination with such further user input devices. However, the user device shown in FIG. 7b may typically be used without such further user input devices: the user device shown in FIG. 7b may, apart from using for example also a general on/off-button, substantially exclusively use its touch screen 111 for user input.

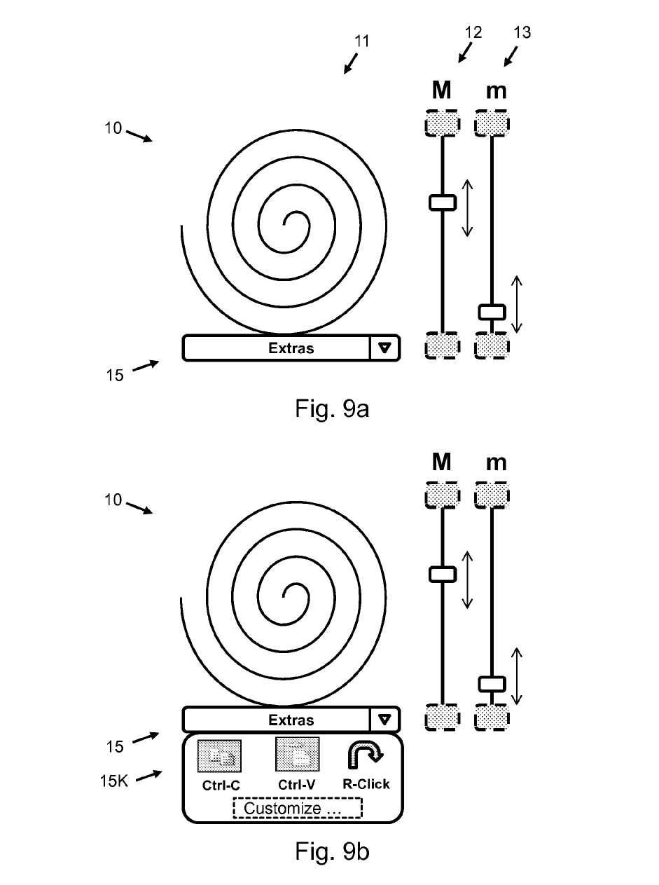

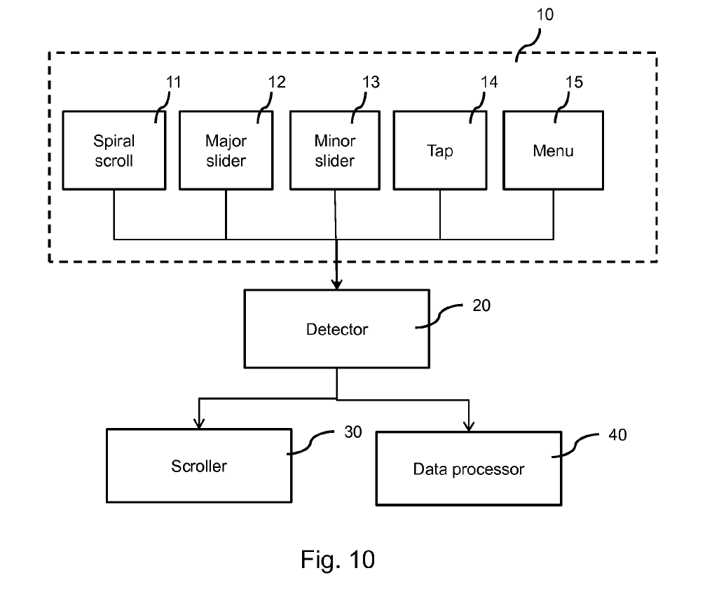

FIG. 8, and FIG. 9a and FIG. 9b schematically shows further examples of a user interface widget 10, and FIG. 10 schematically shows an extended scroll system. For the extended scroll system, only the extensions relative to the scroll system shown in FIG. 4 will be described below.

FIG. 8 schematically shows another example of a user interface widget. The user interface widget 10 may comprise any of the rotation-sensitive scroll area 11, the major scroll bar 12 and the minor scroll bar 13 as described above, and further comprises a plurality of directional tap regions 14U, 14R, 14D, 14L, together referred to as 14. The plurality of directional tap regions is associated with different cursor movement directions on the screen. The detector 20 may further be arranged to detect a user input to a selected directional tap region of the plurality of directional tap regions 14U, 14R, 14D, 14L, and to cause a cursor movement on the screen in accordance with the movement direction associated with the selected directional tap region. For example, directional tap region 14U may correspond to an upward cursor movement and may be used to replace the corresponding arrow key from a keyboard. Likewise may directional tap regions 14R, 14D and 14L correspond to a right, downward and left cursor movement. The directional tap regions 14U, 14R, 14D, 14L may be provided as regions of the rotation-sensitive scroll area 11 and any user input to these regions may be used for scroll control if the user input corresponds to a rotational movement, whereas it may be used for cursor movement if the user input corresponds to a tap event, i.e. a user input at a substantially stationary position. The directional tap regions 14U, 14R, 14D, 14L may comprise a visual presentation of the corresponding direction, e.g., using corresponding arrow symbols. The directional tap regions may alternatively or additionally be provided at a top, a right, a bottom and a left part of the rotation-sensitive scroll area 11. The user interface widget 10 may further comprise a plurality of composed tap regions 14NW, 14NE, 14SE and 14SW at top-left, top-right, bottom-right- and bottom-left parts of the rotation-sensitive scroll area 11. The plurality of composed tap regions may be associated with composed movement directions, each composed movement direction being associated with a movement according to the relative distances of a tap position in the composed tap region to the adjacent directional tap regions 14U, 14R, 14D, 14L. For example, a tap at a tap position in the top-left composed region 14NW at equal distance from the upper directional tap region 14U and the left directional tap region 14L may result in a cursor movement in an upper-left direction, which may be referred to as a north-west direction. The detector 20 may further be arranged to detect a user input to a selected composed tap region of the plurality of composed tap regions 14NW, 14NE, 14SE and 14SW, to determine a composed movement direction and to cause a cursor movement on the screen in accordance with composed movement direction. FIG. 8 further shows that the user interface widget 10 may comprise a resize area 10R.

The resize area 10R may be present together with the plurality of directional tap regions 14U, 14R, 14D, 14L and/or the plurality of composed tap regions 14NW, 14NE, 14SE and 14SW. The resize area 10R may alternatively be present in a user interface widget 10 without the plurality of directional tap regions 14U, 14R, 14D, 14L and/or the plurality of composed tap regions 14NW, 14NE, 14SE and 14SW. The resize area 10R is associated with changing the size of the user interface widget 10 as displayed on the screen. The resize area 10R may correspond to a center region of the rotation-sensitive scroll area 11, e.g. . the central region 110, as shown in FIG. 8. The detector 20 may further be arranged to detect a user selection of the resize area 10R, to determine a user interface widget size and to cause the user interface widget 10 to be presented in accordance with the user interface widget size as determined. Detecting a user selection of the resize area 10R may correspond to detecting a touch without a movement, to distinguish against a scroll input to the user interface widget 10.

In an example, changing the size of the user interface widget may be effected by changing the user interface widget size according to a predetermined sequence in response to detecting one or more user selections of the resize area 10R. A user selection of the resize area 10R may e.g.

be effected by a user touching the resize area 10R For example, the predetermined sequence may correspond to a cyclic-repeated sequence of 10% of a maximum size, 20% of the maximum size, 50% of the maximum size and 100% of the maximum size, whereby subsequent touches change the user interface widget size to 10%, 20%, 50%, 100%, 10%, 20%, 50%, 100%, . . . . The maximum size may e.g. correspond to maximum size wherein the whole user interface widget 10 may be presented on the screen; presenting at such size may be referred to as presenting the user interface widget 10 at the screen size. If the user interface widget 10 is then, at some moment, presented at a user interface widget size of 20% of the screen size, a single touch will increase the user interface widget size to 50% of the screen size, a next touch will increase the user interface widget size to 100% and again a next touch will reduce the user interface widget size to 10%.

In another example, changing the size of the user interface widget may be effected by selecting a user interface widget size during a presentation of the user interface widget 10 with varying user interface widget sizes. For example, when a selection of the resize area 10R is detected, the user interface widget 10 enters a resize state. In the resize state, the user interface widget 10 may first enlarge to a maximum size, such as the screen size, and is subsequently varied in size by reducing in size towards a minimum size, such as for example 10% of the screen size or even smaller. The resize state may be maintained, and the size may accordingly reduce, as long as the resize area 10R maintains selected, e.g., as long as the user continues to touch the resize area 10R or holds down a mouse button. The user may end the resize state by stopping the selection of the resize area 10R, e.g., by releasing the resize area 10R. The size of the user interface widget 10 at the moment of ending the resize state is then selected as the user interface widget size for further presentation of the user interface widget 10.

Hereby, the user may adjust the size of the user interface widget 10 to a desired scale, e.g., according to e.g. personal preferences and/or type of the data set that is being scrolled. FIG. 9a and FIG. 9b schematically shows again another example of a user interface widget. The user interface widget 10 may comprise any of the rotation-sensitive scroll area 11, the major scroll bar 12, the minor scroll bar 13, and optionally the directional tap regions 14U, 14R, 14D, 14L and the composed tap regions 14NW, 14NE, 14SE and 14SW as described above. The user interface widget 11 further comprises a menu 15 comprising a plurality of menu options 15K. The menu 15 may be collapsible and expandable, as shown in FIG. 9a and FIG. 9b. The plurality of menu options may be associated with a plurality of data operations, such as copy (represented by Ctrl-V), paste (represented by Ctrl-V), right click (represented by R-Click), and/or other suitable data operations. The plurality of data options may be pre-determined, or may be customizable, allowing a user to add data operations to be directly accessed from the menu. The detector 20 may further be arranged to detect a user input to a selected menu option of the plurality of menu options and to cause a data processor 40 to perform the menu option associated with the selected menu option.

The examples of FIG. 8 and FIG. 9a and FIG. 9b may be especially suitable where the user does not have such further user input devices available, such as during remotely access using a smartphone with a touchscreen (see FIG. 7b). The directional tap regions and/or composed tap regions and/or menu options may then allow the user to perform a variety of data manipulations from the screen alone.

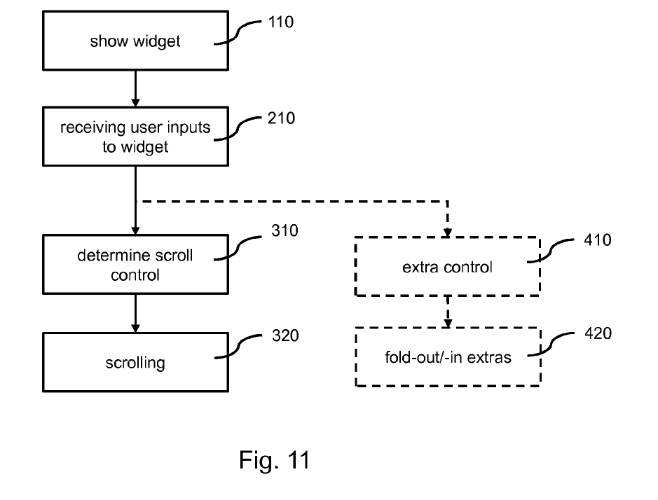

FIG. 11 schematically illustrates an example of an embodiment of a method of scrolling a data set stored in a memory across a screen, the data set having a data set size and a data set resolution. The method, shown in FIG. 11 comprises presenting 110 a user interface widget 10 on the screen, the user interface widget 10 comprising one or more linear scroll bars 12 and a rotation-sensitive scroll area 11. The method further comprises receiving 210 one or more user inputs to the user interface widget 10. The method determining 310 at least a scroll speed, a scroll direction and a scroll resolution from the one or more user inputs, and scrolling 320 the data set across the screen in accordance with the scroll speed, the scroll direction and the scroll resolution.

The user interface widget may further comprise a plurality of directional tap regions 14U, 14R, 14D, 14L associated with different cursor movement directions on the screen. The method may perform 410 cursor movement control from detecting a user input to a selected directional tap region of the plurality of directional tap regions 14U, 14R, 14D, 14L, and moving the cursor on the screen in accordance with the movement direction associated with the selected directional tap region.

The user interface widget may further comprise a plurality of composed tap regions 14NW, 14NE, 14SE and 14SW at top-left, top-right, bottom-right- and bottom-left parts of the rotation-sensitive scroll area 11, and associated with composed movement directions, each composed movement direction being associated with a movement according to the relative distances of a tap position in the composed tap region to the adjacent directional tap regions 14U, 14R, 14D, 14L. The performing 410 of cursor movement may comprise detecting a user input to a selected composed tap region of the plurality of composed tap regions 14NW, 14NE, 14SE and 14SW, determining a composed movement direction and moving the cursor on the screen in accordance with composed movement direction.

The user interface widget 10 may comprise a resize area 10R the resize area 10R being associated with changing the size of the user interface widget 10 as displayed on the screen. The method may further comprise detecting a user selection of the resize area 10R, determining a user interface widget size and causing the user interface widget 10 to be presented in accordance with the user interface widget size as determined. Detecting a user selection of the resize area 10R may comprise detecting a touch without a movement.

The user interface widget 10 may further comprise a menu 15 comprising a plurality of menu options 15K, the plurality of menu options being associated with a plurality of data operations. The method may further comprise menu handling 420 from detecting a user input to a selected menu option of the plurality of menu options and performing the menu option associated with the selected menu option. The menu handling 420 may further comprise detecting a user input to a menu fold-in/fold-out region and folding-in or folding-out the menu accordingly.

The screen may be a touch screen 111 and at least part of the one or more user inputs are received from one or more touches to the user interface widget 10 presented on the touch screen.

At least part of the one or more user inputs may be received one or more mouse clicks on the user interface widget 10 presented on the screen 11.

The method being performed using a host device 100 and a user device 110, the screen 111 being part of the user device remotely accessing the host. The method may further comprise obtaining the data set in dependence on a further user action. The further user action may e.g. be a search query giving search results as the data set, a debugging action giving debugging information as the data set, collecting a memory trace from an embedded system as a data set, downloading information from a web site to obtain the data set, providing a file with file content forming the data set, or any other action providing a data set of a significant size.

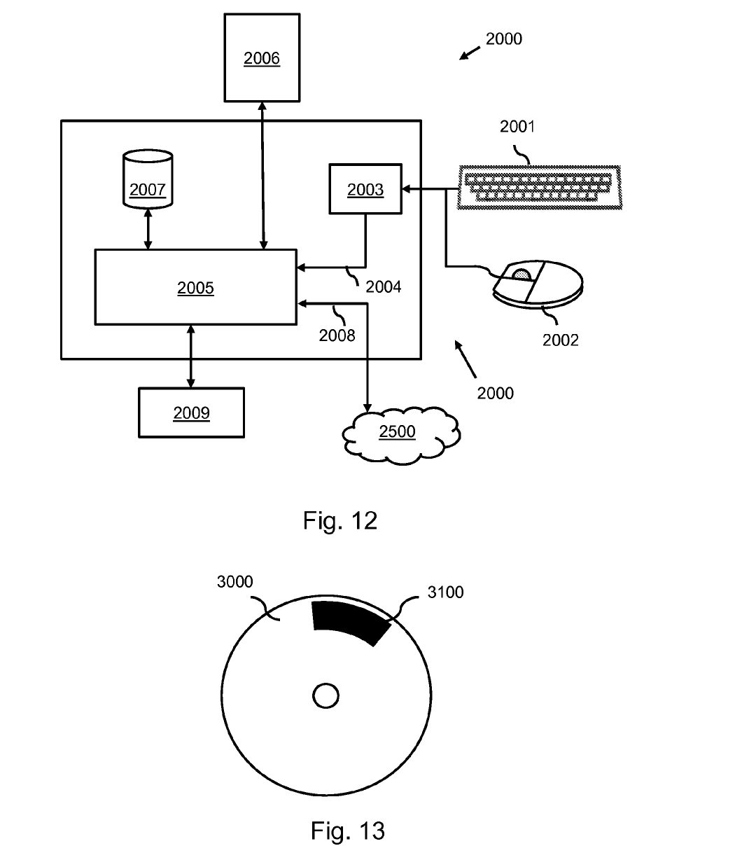

FIG. 12 schematically shows an exemplary user interaction system 2000 having a programmable processor 2005. The user interaction system 2000 is shown to be a personal computer, but may be any type of suitable user interaction system 2000. The user interaction system 2000 may correspond to the systems schematically shown in FIG. 7a or FIG. 7b, but may be any type of suitable user interaction system 2000. The programmable processor may comprise detector 20 and/or scroller 30 and/or data processor 40. The user interaction system 2000 further comprises a storage unit 2007, a user input 2003 and a display 2006, which may be the same as screen 111B in FIG. 7a, the same as screen 111 in FIG. 7b, or an additional display. The user input 2003 allows the user to directly input user data and user instructions 2004 to the processor 2005 by e.g. using a keyboard 2001 or a mouse 2002. Also, although not shown, the display 2006 may comprise a touch-sensitive surface for enabling the user to provide user data and user instructions to the user input 2003 by means of touching the display 2006. The processor 2005 is arranged to perform any one of the methods according to the invention, to receive user data and user instructions 2004, to present visual information on the display 2006 and to communicate with a data I/O device 2009, such as an optical disc drive or a solid state reader/writer. The processor 2005 is arranged to cooperate with the storage unit 2007, allowing storing information on and retrieving information on the storage unit 2007, such as one or more data sets that may be scrolled across the screen. The processor 2005 may be arranged to obtain one or more data sets that may be scrolled across the screen in response to a user action and sore the one or more data sets in the storage unit 2007. The user interaction system 2000 may further comprise a communication channel 2008 allowing the processor 2005 to connect to an external cloud 2500 for communicating with other devices in the cloud. The external cloud may e.g. be the Internet. The processor 2005 may also be arranged to retrieve one or more data sets from another device in the cloud 2500. . The processor 2005 may also be arranged to retrieve one or more data sets from the data I/O device 2009. The one or more data sets may thus be retrieved from a memory formed by storage unit 2007 and/or the data I/O device 2009 and/or the cloud 2500. The processor 2005 may be capable to read, using the data I/O device 2009, a computer readable medium comprising a program code. The processor 2005 may be capable to read, using the data I/O device 2009, a computer readable medium comprising a computer program product comprising instructions for causing the user interaction system 2000 to perform a method of scrolling a data set stored in a memory across a screen as defined in any one of the appended claims.

FIG. 13 shows a computer readable medium 3000 comprising a computer program product 3100, the computer program product 3100 comprising instructions for causing a processor apparatus to perform a method as defined in any one of the appended claims. The computer program product 3100 may be embodied on the computer readable medium 3000 as physical marks or by means of magnetization of the computer readable medium 3000. However, any other suitable embodiment is conceivable as well. Furthermore, it will be appreciated that, although the computer readable medium 3000 is shown in FIG. 13 as an optical disc, the computer readable medium 3000 may be any suitable computer readable medium, such as a hard disk, solid state memory, flash memory, etc., and may be non-recordable or recordable.

The invention may thus also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device. Also, devices functionally forming separate devices may be integrated in a single physical device.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of scrolling a data set stored in a memory across a screen, the data set having a data set size and a data set resolution, the method comprising:
presenting a user interface widget on the screen, the user interface widget comprising one or more linear scroll bars comprising a slider and a rotation-sensitive scroll area,
receiving one or more user inputs to the user interface widget
determining at least a scroll speed, a scroll direction and a scroll resolution from the one or more user inputs to obtain a scroll control signal, and
scrolling the data set across the screen in accordance with the scroll control signal.

2. A method according to claim 1, the rotation-sensitive scroll area comprising at least a central region and an outer region, the central region and the outer region being associated with scrolling at different scroll speeds.

3. A method according to claim 2, the central region being associated with a larger scroll speed than the outer region.

4. A method according to claim 2, the central region and the outer region being associated with scrolling at a scroll resolution corresponding to the data set resolution.

5. A method according to claim 2, the scroll direction being determined from a rotational movement of a user input to the rotation-sensitive scroll area.

6. A method according to claim 2, the rotation-sensitive scroll area comprising a presentation of a spiral object, the spiral object having a plurality of turns.

7. A method according to claim 2, the rotation-sensitive scroll area comprising a presentation of a circular object, the circular object comprising a plurality of concentric circles.

8. A method according to claim 1, the one or more linear scroll bars comprising a major scroll bar and a minor scroll bar the major scroll bar and the minor scroll bar being associated with different scroll resolutions.

9. A method according to claim 8, the major scroll bar being associated with scrolling the data set across the screen at a subset resolution in response to a user input to the major scroll bar to obtain a selected subset of a plurality of subsets of the data set, the plurality of subsets together forming the data set, and the minor scroll bar being associated with scrolling the selected subset across the screen at the data set resolution in response to a user input to the minor scroll bar.

10. A method according to claim 8, the major scroll bar and the minor scroll bar comprising scroll tap regions, the scroll tap regions of the scroll bars being associated with scrolling by one step of the associated resolution.

11. A method according to claim 1, the user interface widget comprising a plurality of directional tap regions, the plurality of directional tap regions being associated with different cursor movement directions on the screen.

12. A method according to claim 1, the user interface widget further comprising a resize area, the resize area being associated with changing the size of the user interface widget as displayed on the screen, and the method further comprising detecting a user selection of the resize area, determining a user interface widget size and causing the user interface widget to be presented in accordance with the user interface widget size as determined.

13. A method according to claim 1, the user interface widget further comprising a menu comprising a plurality of menu options, the plurality of menu options being associated with a plurality of data operations and the method further comprising detecting a user input to a selected menu option of the plurality of menu options and performing the menu option associated with the selected menu option.

14. A method according to claim 1, wherein the screen is a touch screen and at least part of the one or more user inputs are received from touch(es) to the user interface widget presented on the touch screen.

15. A method according to claims 1, wherein at least part of the one or more user inputs are received as mouse click(s) on the user interface widget presented on the screen.

16. A method according to claim 1, the method being performed using a host device and a user device, the screen being part of the user device remotely accessing the host.

17. A method according to claim 1, the method further comprising obtaining the data set in dependence on a user request.

18. A computer program product comprising instructions for causing a processor system to perform a method of scrolling a data set stored in a memory across a screen, according to of claim 1.

19. (canceled)

20. A device comprising a processor arranged to perform a method according to claim 1.

21. A system comprising a host device and a user device, the system having a memory for storing a data set, the user device having a screen, the host device and the user device being arranged to perform a method of scrolling a data set stored in the memory of the host device across the screen of the user device as defined in claim 1.
